(19) United States
(12) Patent Application Publication
(10) Pub. No.: US 2022/0294296 A1
(43) Pub. Date: Sep. 15, 2022

(54) METHOD AND DEVICE FOR PRODUCING AN ELECTRIC MACHINE, ELECTRIC MACHINE AND GROUP OF ELECTRIC MACHINES

(71) Applicant: Fraunhofer-Gesellschaft zur Förderung der angewandten Forschung e.V., München (DE)

(72) Inventors: Franz-Josef Wöstman, Bremen (DE); Matthias Busse, Bremen (DE)

(21) Appl. No.: 17/639,645

(22) PCT Filed: Sep. 1, 2020
(86) PCT No.: PCT/EP2020/074346

§ 371 Date: Mar. 2, 2022

(30) Foreign Application Priority Data
Sep. 2, 2019 (DE) 10 2019 213 232.4

(51) Int. Cl. H02K 3/02; H02K 3/24; H02K 15/04

(52) U.S. Cl. CPC H02K 3/02; H02K 3/24; H02K 15/0435; H02K 2213/03

(57) ABSTRACT

Method for producing an electric machine. Proceeding from a defined construction of the machine depending on one or more parameters that correspond to a maximum value of a mean current density over time in the one or more winding(s), and the price category, a design of the winding is allocated from a number of defined designs, wherein the designs comprise in particular a cast winding made of copper, a cast winding made of a copper alloy, a cast winding made of aluminium, a cast winding made of an aluminium alloy, a cast winding made of magnesium, a cast winding made of a conductive plastic, an insulating system, wherein the list from which the design of the insulating system is selected comprises insulating systems of the thermal class 180° C., the thermal class 250° C. and the thermal class 300° C., a cooling system selected from the designs of an air cooling system, a direct water cooling system, an indirect water cooling system, or a subselection of these designs.

### CROSS REFERENCE TO RELATED APPLICATIONS

The present application is a national stage application of International Application No. PCT/EP2020/074346, filed Sep. 1, 2020, which claims priority to German Application No. 102019213232.4, filed Sep. 2, 2019, the disclosures of which are hereby incorporated by reference in their entireties.

### FIELD OF THE DISCLOSURE

The invention is in the field of mechanical engineering and production engineering and relates in particular to a method for producing an electric machine comprising laminated cores and electrical windings, and to an electric machine.

### BACKGROUND OF THE DISCLOSURE

Usually, electric machines, such as electric motors or generators, are designed to have laminated cores and wound electrical coils. In this case, in order to generate magnetic fields, electrical coils made of flexible conductors are wound around parts of the laminated cores. Round wire is often used for this purpose, i.e. a strand-shaped electrical conductor that is circular in cross section and is wound to form a coil, usually in multiple layers, which are also referred to as windings. The cross section relates to a sectional surface oriented to be spatially perpendicular to the longitudinal direction of the electrical conductor predetermined by the strand shape of the conductor, the longitudinal direction having an orientation substantially in parallel with the strand. The usage of the space available for the coil by the material actually available as the conductor cross section is limited here and is generally between 30% and 55% of the ideal value at which the available space could be fully utilized for current conduction.

Various forms of electrical coil for electric machines have already been proposed for utilizing economies of scale in the production of such electric machines. In this process, in order to reduce the costs of a rotor, stator, laminated cores and other parts as far as possible, coils should be produced in different variants.

Up to now, an individual requirement placed on an electric machine, for example a power or torque class, has usually been implemented by modifying or adapting the length or diameter of the electric machine such that the individual requirement is met. Power can also be adapted by adjusting the power electronics, with the hardware components of the machine being oversized for many cases here, since they have to be designed for the highest current density and the associated heat-dissipation requirements. Other individual requirements may for example relate to a thermal class, a cooling system or a price of the electric machine, with it being possible to allocate the price to a price category with regard to its numerical value.

In some cases, in order to fill the space available for the electrical windings as fully as possible, already cast metal coils have been proposed which both allow the cross section of the conductor to be designed as desired and also allow the outer shape of the winding to be shaped. Using a cast coil, the installation space, which is enlarged outwards orthogonally to the rotational axis of the electric machine, can be utilized optimally. When the size of the cross section of the conductor remains constant along such a coil, the cross-sectional shape of the conductor can change along the coil axis in order to optimize the use of space and heat distribution in the coil. This allows for a higher level of efficiency and a higher current density within the coil.

### SUMMARY

Against the background of the prior art, the problem addressed by the present invention is to provide a method for producing an electric machine in which it is possible to design the electric machine in the simplest possible manner with regard to an individual requirement.

The problem is solved by the features of the invention according to the claims. The claims relate to possible configurations of the method for producing the electric machine. In addition, the invention relates to an apparatus for producing an electric machine.

The claimed method relates to the production of an electric machine which comprises a laminated core and one or more windings, which each surround a tooth of the laminated core. In the method, it is provided that, proceeding from a defined construction of the machine comprising a defined laminated core of the electric machine to be produced, a design of the winding is allocated from a number of defined designs depending on one or more of the parameters of maximum torque, maximum power and minimal cooling power that correspond to a maximum value of a mean current density over time in the one or more winding(s), as well as the price category, the designs in particular comprising a cast winding made of copper, a cast winding made of a copper alloy, a cast winding made of aluminum, a cast winding made of an aluminum alloy, a cast winding made of magnesium, a cast winding made of a conductive plastics material, optionally a winding wound from a wire, an insulating system, the list from which the design of the insulating system is selected comprising insulating systems of the 180° C. thermal class, the 250° C. thermal class and the 300° C. thermal class, a cooling system, to which the one or more winding(s) can be connected, selected from the designs of an air cooling system, a direct water cooling system, an indirect water cooling system, or a subselection of these designs.

An air cooling system is designed to supply the cooling structures, for example the cooling ducts or cooling fins, with an air flow that dissipates heat that may develop in the windings during machine operation. The air cooling system can for example be constructed with the aid of a fan and may also comprise other connection elements, for example a pipe and/or a tube, which conduct the air flow generated by the fan to the cooling structures. The air heated in the cooling structures may be output to a heat exchanger or to the surroundings, for example.

A water cooling system is designed to supply the cooling structures, for example the cooling ducts or cooling fins, with water such that the water can flow therethrough and dissipates heat that may develop in the windings during machine operation. A water cooling system can for example be constructed with the aid of a pump and may also comprise other connection elements, for example a pipe and/or a tube, which conduct the flow of water generated by the pump to the cooling structures. The water heated in the cooling structures may be output to a heat exchanger, for example.

Direct water cooling is designed to supply the cooling structures in the windings, for example the cooling ducts or cooling fins, with water.

Indirect water cooling is designed to supply other components, i.e. components different from the windings, for example a laminated core of the electric machine or other parts of the electric machine, such as a bearing or housing, which are thermally connected to the windings, with water, such that the heat that builds up here during machine operation can be dissipated.

The materials to be used in the winding may, for example, be selected after inputting the parameters of the electric machine to be fulfilled by a data-processing system using a computer program or by a hard-wired automatic controller. A material of which the electrical winding to be used consists may for example be allocated in each case to various requirement parameters of the electric machines in a database or a simple memory apparatus within a control apparatus.

In the method, by selecting a cost-effective winding, first of all the most cost-effective machine can be configured and a data-processing apparatus can determine whether this machine meets the stipulated electrical and mechanical requirements. If this is not the case, it can be swapped for the next most efficient configuration of the winding and this configuration can be calculated with regard to the electrical and mechanical performance. In this way, the machine configured in each case can be compared with the existing requirements until all the requirements are met, with the lowest possible costs being selected for the machine in this case. In this case, each of the individual selected windings has the same geometric dimensions and they differ only in the material selection and for example also in the selection of the cross-sectional shape of the conductor. In this case, in order to fulfil special conditions, wound coils made of the stated materials can also be selected in addition to the cast coils. In addition, a selection can optionally be made from the stated cooling structures.

In one configuration of the method, it may be the case that the permissible mean current density over time in the one or more cast winding(s) made of copper or a copper alloy, for a time period, based thereon, of at least 1 minute, preferably at least 10 minutes, particularly preferably at least 1 hour and, in particular, particularly preferably at least one 1 day,
has a maximum value of greater than 10 A/mm², preferably greater than 12 A/mm², when connected to an air cooling system,
has a maximum value of greater than 20 A/mm², preferably greater than 24 A/mm², when connected to an indirect water cooling system,
has a maximum value of greater than 60 A/mm² when connected to a direct water cooling system.

The current density indicates an electrical current based on the cross-sectional area of the electrical conductor through which the electrical current passes in the longitudinal direction of the electrical conductor. In an electrical conductor having an electrical resistance, the generated power loss, i.e. the heat generated, is proportional to the square of the current density. The electrical current may be a direct current or alternating current, for example. With an alternating current, the electrical current can be indicated by means of an effective value, which is known to a person skilled in the art. In the case of an alternating electrical current, the values of the indicated mean current densities over time relate to values ascertained by means of the effective value of the electrical current.

The heat actually generated is determined by the duration for which the current density occurs in the electrical conductor. When considered over a time period, a description of the heat generated with a mean current density over time may be helpful for this purpose. The mean current density over time relates to a mean of the current density over time based on a time period. The current density is averaged over time over the relevant time period, for example 1 minute, 10 minutes, 1 hour or 1 day. For example, to do this, the current density may be mathematically integrated over this time period and the result of this mathematical integration can be divided by the duration of the time period.

Here, “permissible mean current density over time” means that the value or level of the permissible mean current density over time does not result in damage to the windings, the machine and/or parts of the machine that contributes to it not being possible to reach an intended duration of use of the machine or to unacceptable risks stated in the relevant technical standards known to a person skilled in the art, for example.

The method may also be configured such that the permissible mean current density over time in the one or more cast winding(s) made of aluminum or an aluminum alloy, for the 180° C. thermal class of the insulating system, for a time period, based thereon, of at least 1 minute, preferably at least 10 minutes, particularly preferably at least 1 hour and, in particular, particularly preferably at least one 1 day,
has a maximum value of greater than 6 A/mm², preferably greater than 7 A/mm², when connected to an air cooling system,
has a maximum value of greater than 12 A/mm², preferably greater than 14 A/mm², when connected to an indirect water cooling system,
has a maximum value of greater than 35 A/mm² when connected to a direct water cooling system.

One configuration of the method involves the possibility that the permissible mean current density over time in the one or more cast winding(s) made of aluminum or an aluminum alloy, for the 250° C. thermal class of the insulating system, for a time period, based thereon, of at least 1 minute, preferably at least 10 minutes, particularly preferably at least 1 hour and, in particular, particularly preferably at least one 1 day,
has a maximum value of greater than 7 A/mm², preferably greater than 15 A/mm², when connected to an air cooling system,
has a maximum value of greater than 14 A/mm², preferably greater than 25 A/mm², when connected to an indirect water cooling system,
has a maximum value of greater than 45 A/mm² when connected to a direct water cooling system.

One configuration of the method also involves the possibility that the permissible mean current density over time in the one or more cast winding(s) made of aluminum or an aluminum alloy, for the 300° C. thermal class of the insulating system, for a time period, based thereon, of at least 1 minute, preferably at least 10 minutes, particularly preferably at least 1 hour and, in particular, particularly preferably at least one 1 day,
has a maximum value of greater than 8 A/mm², preferably greater than 17 A/mm², when connected to an air cooling system,
has a maximum value of greater than 16 A/mm², preferably greater than 30 A/mm², when connected to an indirect water cooling system,
has a maximum value of greater than 56 A/mm² when connected to a direct water cooling system.

In order to produce an electric machine according to the method set out above, the invention may also relate to an apparatus for producing an electric machine comprising a laminated core and one or more windings, which each surround a tooth of the laminated core. In such an apparatus, it may be provided that the apparatus comprises a data-processing unit having a memory apparatus in which a plurality of different designs of the winding are stored which have the same outer dimensions, and the data-processing unit being configured to detect one or more of the parameters of maximum torque, maximum power and minimal cooling power that correspond to a maximum value of a mean current density over time in the one or more cast winding(s), as well as the price category, and to allocate one of the designs stored in the memory apparatus to said winding(s) proceeding from a defined construction of the machine comprising a defined laminated core, the designs in particular comprising a cast winding made of copper, a cast winding made of a copper alloy, a cast winding made of aluminum, a cast winding made of an aluminum alloy, a cast winding made of magnesium, a cast winding made of a conductive plastics material, optionally a winding wound from a wire, an insulating system, the list from which the design of the insulating system is selected comprising insulating systems of the 180° C. thermal class, the 250° C. thermal class and the 300° C. thermal class, a cooling system, to which the one or more winding(s) can be connected, selected from the designs of an air cooling system, a direct water cooling system, an indirect water cooling system, or a subselection of these designs.

The invention also relates to an electric machine comprising a laminated core and one or more windings, which each surround a tooth of the laminated core, wherein it is also provided that at least one, in particular a plurality of or all the teeth of the laminated core each comprise a retaining device for a slid-on winding, which, after sliding the winding onto the tooth, can be brought into a blocking position and prevents displacement and/or movement of the winding on the tooth.

For this purpose, it may for example be provided that the retaining device comprises a bar, which can be slid or folded out of the contour of the relevant tooth from a recess in the tooth into a blocking position.

The retaining device makes it possible to slide prefabricated, in particular cast, coils onto the core teeth of the laminated core of a machine in a simple manner, which coils can be effectively mechanically fixed as a result. In addition, such a retaining device is also intended to be used to retain an electrical winding that is optionally to be wound, for example, such that no structural adaptations to the laminated core are required for positioning an electrical coil, regardless of design.

The invention also relates to an electric machine comprising a laminated core and one or more windings, which each surround a tooth of the laminated core, the electrical machine, additionally or alternatively to the retaining device, being characterized in that one or more of the windings are cast windings comprising cooling structures.

The cooling structures may be cooling ducts or cooling fins, for example. Cooling fins may for example be cast on and ducts may for example be made during casting or by finishing.

In addition, the application relates to a group of electric machines, in particular generators and/or motors, which are equipped with identically constructed laminated cores, the machines being equipped with windings which each surround teeth of the laminated cores. The problem is solved according to the invention by at least two of the machines differing in terms of the design of the windings.

In this case, the different windings may be selected from different cast windings and from wound windings that are wound from wire. In particular, all of the windings may also be cast windings here, with said windings differing from one another in terms of the material used or in other coil parameters, for example. Typically, conductive materials that can be cast are used.

The differing windings may in particular be selected from the following designs or a subselection of the following designs: cast winding made of copper, cast winding made of a first copper alloy, cast winding made of a second copper alloy, cast winding made of aluminum, cast winding made of a first aluminum alloy, cast winding made of a second aluminum alloy, cast winding made of magnesium, cast winding made of a conductive plastics material, optionally a winding wound from a wire.

By using identical laminated cores, windings that have the same outer shape can be used for different electric machines having different power data. This results in more cost-effective production of the laminated cores for a larger number of machines, with the power requirements on the individual machines being met by specifically selecting from the various available windings. In this case, the individual windings have the same outer geometric shape, such that all the windings can each be applied to identical teeth on laminated cores, and the various windings differ on account of the different material selection, for example. As a result, groups of machines can be produced in which a first machine satisfies first power requirements while a second and/or additional machine satisfies second power requirements which differ from the first power requirements.

Cooling structures may be present on or in the windings. These may be designed as cooling ducts and/or cooling fins, for example. If these are external cooling structures, the space they require is taken into account when selecting the windings. Typically, in any case in which cooling structures are present, an increase in power that can be obtained by the cooling structures is taken into account in the selection. Whether or not cooling structures are present and how they are designed thus constitutes another parameter that can be adjusted in the present case, in addition to the selection of the windings, and can be taken into account in the production method.

The individual requirements on the different machines in a group can be implemented in a particularly cost-effective manner by varying the windings and selecting the winding that is suitable in each case and is as cost-effective as possible. In this case, windings made of copper or a copper alloy can be selected, for example, if particularly high electrical power requirements and a high current-carrying capacity is required with low heat loss. In particular when using the purest possible copper, particularly low electrical resistance results and provides the option of conducting an electrical current having a high current intensity. If the electrical power requirements are lower, aluminum or an aluminum alloy can be used, for example, meaning that the costs can be reduced. The use of each of the metals in pure form may make sense when there are special requirements, but the use of alloys makes it possible to process the metals in a simplified manner and therefore allows for simplified, robust processing operations. In this case, the outer geometric shape of the windings that can be used can be identical for all the variants of the material selection in principle.

Here, a particular configuration of the invention may provide that the differing windings are selected from the following designs: cast winding made of copper, cast winding made of a first copper alloy, cast winding made of a second copper alloy. Therefore, in a group of machines having consistently high electrical requirements, the differences in the electrical performance of the machines can be obtained by varying different copper materials.

Another configuration of the invention may provide that the differing windings are selected from the following designs: cast winding made of aluminum, cast winding made of a first aluminum alloy, cast winding made of a second aluminum alloy. In this way, in a group of electric machines that can be produced as cost-effectively as possible, different requirements placed on the individual machines can be met by varying the winding material in the form of different aluminum materials.

Other configurations, in particular for special applications, may provide that at least one winding is a winding cast from magnesium or a winding cast from a conductive plastics material.

In another example for implementing the invention, it may advantageously be provided that the differing windings are selected from the following designs: cast winding made of a copper alloy, cast winding made of an aluminum alloy, optionally a winding wound from a wire. In this case, copper materials or copper-containing materials in one machine can be combined with aluminum-containing materials in another machine when configuring the winding, such that very different requirements on the individual electric machines can be met in one group of machines in a simple manner.

In one configuration of the invention, there is the possibility that the differing windings comprise an insulating system, a list from which the design of the insulating system is selected comprising insulating systems of the following thermal classes: the 180° C. thermal class, the 250° C. thermal class and the 300° C. thermal class. Dividing insulating systems into thermal classes is known to a person skilled in the art.

There is also the possibility, according to the invention, that the differing windings can be connected to a cooling system, the cooling system being selected from the following designs: an air cooling system, a direct water cooling system, an indirect water cooling system.

### BRIEF DESCRIPTION OF THE DRAWINGS

In the following, the invention will be shown and subsequently described on the basis of embodiments in figures of the drawings, in which:

FIG. 1 is a schematic cross section through a laminated core of an electric machine comprising a tooth and the contour of a winding that can be slid onto the tooth;

FIG. 2a is a schematic longitudinal section through an electrical winding;

FIG. 2b is a schematic longitudinal section through an electrical winding comprising a cooling duct'

FIG. 2c is a schematic side view of an electrical winding comprising cooling fins;

FIG. 3 is a longitudinal section through another electrical winding;

FIG. 4 schematically shows a method for producing an electric machine;

FIG. 5 shows an apparatus for producing an electric machine;

FIG. 6 is a cross section through three different electric machines; and

FIG. 7 shows a tooth of a laminated core comprising a retaining device for a winding.

### DETAILED DESCRIPTION OF THE DRAWINGS

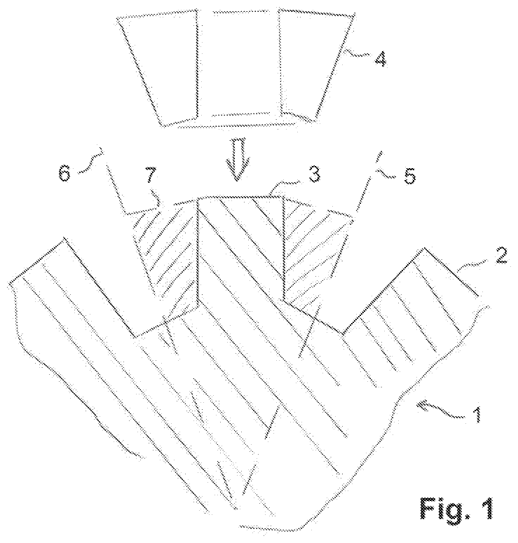

FIG. 1 is a cross section through a laminated core 1 of an electric machine, with a plurality of teeth 2, 3 being shown over the circumference of the laminated core 1. Between the individual teeth 2, 3 of the laminated core, there is space for electrical windings 4, which each surround an individual tooth 2, 3. The space around the tooth 3 available for a winding is defined by the dashed lines 5, 6, is shaded and is denoted by reference numeral 7. When there are high power requirements on the electric machine, this space 7 needs to be utilized as efficiently as possible, i.e. it must be possible to achieve the highest possible current density in this space. To do this, it is necessary to fill a particular high proportion of the space with a highly conductive electrical conductor. This requirement can be met by cast coils in particular. For electric machines with lower power requirements, a conventional coil may also be wound around the tooth 3 by means of a strand-shaped, flexible conductor.

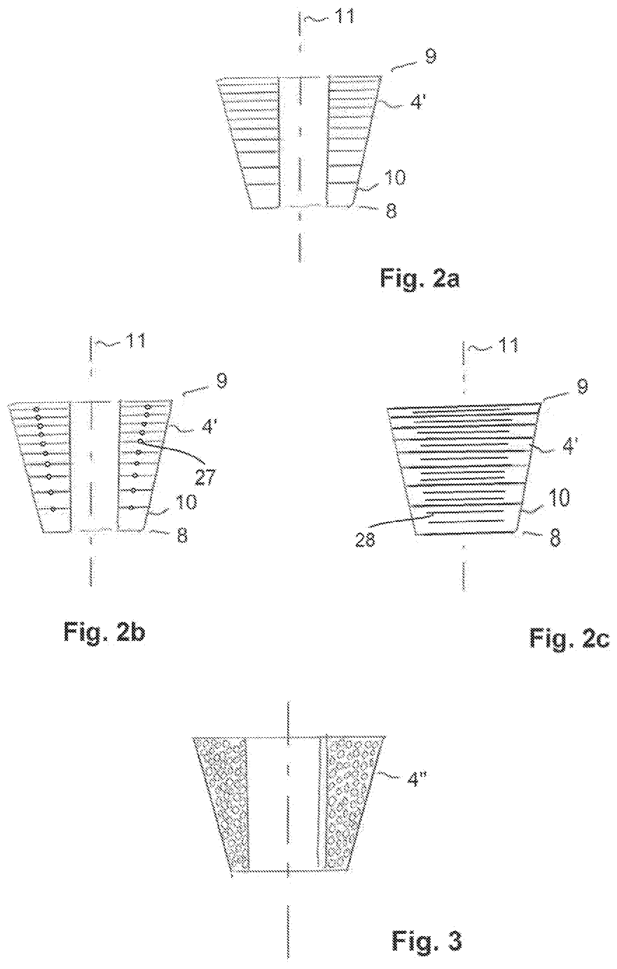

FIG. 2a is an exemplary longitudinal section through a cast coil 4′, with the extension of the cross sections of the helical conductor 10 enlarging in the radial direction of the coil 4′ and reducing in the direction parallel to the axis 11 from the first end 8 of the coil 4′ towards the second end 9. This is an exemplary configuration of a conductor having a variable cross section, with the use of conductors having a constant cross section along the coil likewise being possible. In the arrangement shown in FIG. 2, a constant cross-sectional area of the conductor 10 results along the coil, such that the current-carrying capacity remains constant in the entire coil. Therefore, optimal heat distribution of the heat loss in the coil can be achieved.

The material of the conductor 10 of which the cast coil 4′ consists can be selected according to the electrical requirements on the machine and the price requirements and other requirements, for example mechanical requirements, on the electric machine. For example, pure copper or aluminum or copper alloys, aluminum alloys, magnesium or other metal alloys can be selected. Conductive plastics material also comes into consideration, in particular for special applications.

FIG. 2b shows the same section as in FIG. 1. The cast winding 4′ comprises cooling ducts 27 here, through which a coolant can flow. The cooling ducts 27 may be produced during casting or by finishing. In the example shown, they are implemented by recesses on the flat sides of adjacent windings and thus extend between the windings. The cooling ducts may, however, also be in the interior of the windings, for example.

FIG. 2c is a plan view of the cast winding 4′, with the same viewing direction being selected as in FIGS. 2a and 2b. An outer face of the cast winding 4′ can be seen, on which the superimposed windings are visible. On this outer face, cast-on cooling fins 28 are visible on the windings 4′. The outer face shown is particularly suitable for providing the cooling fins 28, since it typically does not face an adjacent winding 4′ and the additional installation space required by the cooling fins 28 does not come at the expense of the use of space between the adjacent teeth.

FIG. 3 is a longitudinal section through a coil 4″ wound from a wire-shaped conductor. It is clear that there are spaces between the individual windings of the coil due to the round cross section of the conductor, and these spaces limit the electrical performance of the coil. Nevertheless, this type of coil can also be optimized for certain power requirements in relation to the price.

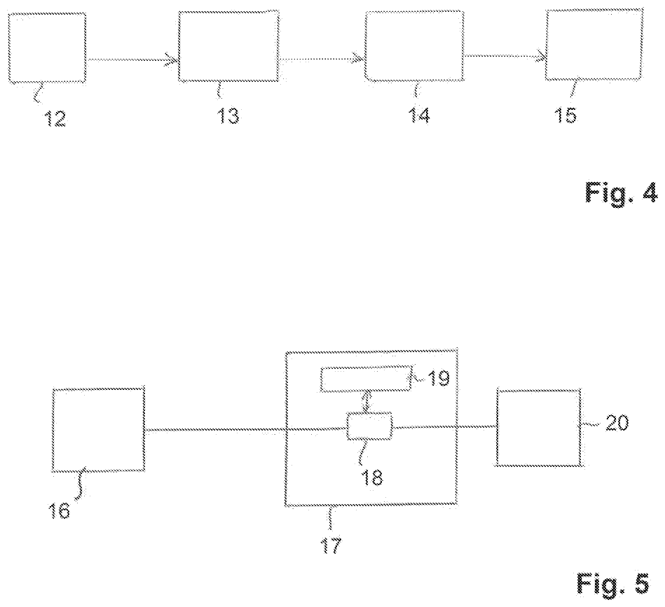

FIG. 4 schematically shows a method for producing an electric machine, in which, in a first method step 12, the electrical requirements of the machine, and optionally mechanical requirements and price requirements, are ascertained and recorded in a data-processing apparatus. In a second step 13, from this information and from a fixed outer contour of the coils with a given design of the electric machine, the type of coil and the material of the conductor of the coil are determined with which the given requirements can be met. Subsequently, in another method step 14, a number of coils of the determined type are produced, and, in a method step 15, are applied to and brought into contact with the laminated core, optionally the teeth of the laminated core of the electric machine to be produced.

FIG. 5 schematically shows a device for producing electric machines, with reference numeral 16 denoting an input device by means of which the electrical, mechanical and price requirements can be recorded in the electric machine to be produced. The type of the electric machine can be specified in many details, down to the type of electrical coils to be used.

Reference numeral 17 denotes a data-processing apparatus which comprises a processor unit 18, which allocates the parameters of the coils to be produced to the input data from the input unit 16 by means of a database 19. In particular, the material of the conductors and optionally also a cross-sectional shape of the conductors and/or a cooling structure are allocated to the coils to be produced. The processor unit 18 then passes the data on the coils to be produced to an output unit 20. Said unit can display the parameters such that the production and assembly of the coils can then be ordered, or the output unit 20 may already be configured as part of an automatic production device for electric machines and may control either the selection of suitable coils from a warehouse or the production of suitable coils in an automatic manner.

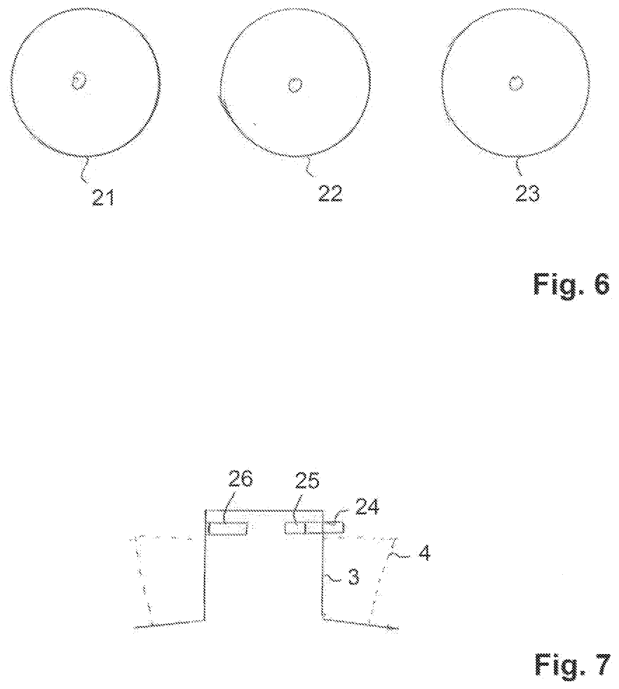

FIG. 6 shows, by way of example, a group of three electric machines, in particular electric motors, of which a first machine 21 comprises windings made of drawn round copper wire, the second machine 22 comprises cast copper coils, and the third machine 23 comprises cast aluminum coils. The coils in all three machines have the same outer dimensions, and the same applies to the laminated cores.

The first machine 21 is particularly cost-effective, the second machine 22 achieves a particularly high current-carrying capacity and power, and the third machine 23 is particularly mechanically stable. The machines form a group of machines that can be produced cost-effectively and can be adapted to the requirements.

FIG. 7 shows a tooth 3 of a laminated core comprising two bars 24, 26, which can be slid into recesses 25 in the tooth 3 such that, in the fastened state, they project out of the tooth and retain a winding positioned on the tooth.

The invention makes it possible to produce different electric machines by means of one construction platform, with the type of the electric machine, including the laminated cores, being able to be configured such that the different requirements on the electrical and mechanical performance and on the service life and price can be met solely by designing the electrical coils by means of selecting suitable materials for the coil conductors.

The present disclosure includes the following aspects, inter alia:
1. A group comprising two or more rotating electric machines (21, 22, 23), in particular generators and/or motors, which are equipped with identically constructed laminated cores, the machines (21, 22, 23) being equipped with windings (4, 4′, 4″) which each surround teeth (2, 3) of the laminated cores, characterized in that at least two of the machines (21, 22, 23) differ in terms of the design of the windings, the differing windings (4, 4′, 4″) in particular being selected from different cast windings and windings wound from wire.
2. The group of electric machines (21, 22, 13) according to aspect 1, characterized in that the differing windings (4, 4′, 4″) are selected from the following designs or a subselection of the following designs: cast winding made of copper, cast winding made of a first copper alloy, cast winding made of a second copper alloy, cast winding made of aluminum, cast winding made of a first aluminum alloy, cast winding made of a second aluminum alloy, cast winding made of magnesium, cast winding made of a conductive plastics material, winding (4″) wound from a wire.
3. The group of electric machines (21, 22, 13) according to aspect 1, characterized in that the differing windings (4, 4′, 4″) are selected from the following designs: cast winding made of copper, cast winding made of a first copper alloy, cast winding made of a second copper alloy.
4. The group of electric machines according to aspect 1, characterized in that the differing windings (4, 4′, 4″) are selected from the following designs: cast winding made of aluminum, cast winding made of a first aluminum alloy, cast winding made of a second aluminum alloy.
5. The group of electric machines according to aspect 1, characterized in that the differing windings (4, 4′, 4″) are selected from the following designs: cast winding made of a copper alloy, cast winding made of an aluminum alloy, winding wound from a wire.
6. A method for producing a rotating electric machine (21, 22, 23) comprising a laminated core and one or more windings (4, 4′, 4″), which each surround a tooth (2, 3) of the laminated core, characterized in that, proceeding from a defined construction of the machine comprising a defined laminated core of the electric machine to be produced, a design of the winding (4, 4′, 4″) is allocated from a number of defined designs depending on one or more of the parameters of maximum torque, maximum power and price category, the designs in particular comprising a cast winding made of copper, a cast winding made of a copper alloy, a cast winding made of aluminum, a cast winding made of an aluminum alloy, a cast winding made of magnesium, a cast winding made of a conductive plastics material, and a winding wound from a wire, or a subselection of these designs.
7. The method according to aspect 6, characterized in that the defined designs of windings (4, 4′, 4″) available for selection in order to be allocated to the electric machine (21, 22, 13) each have the same geometric dimensions.
8. The method according to aspect 6 or 7, characterized in that a cast winding is equipped with cooling structures, preferably in the form of cooling ducts (27) or cooling fins (28).
9. An apparatus for producing a rotating electric machine (21, 22, 23) comprising a laminated core and one or more windings (4, 4′, 4″), which each surround a tooth (2, 3) of the laminated core, characterized in that the apparatus comprises a data-processing unit (17) having a memory apparatus (19) in which a plurality of different designs of the winding are stored which have the same outer dimensions, and the data-processing unit being configured to detect one or more of the parameters of maximum torque, maximum power and price category, and to allocate one of the designs stored in the memory apparatus (19) to said winding(s) proceeding from a defined construction of the machine comprising a defined laminated core, the designs in particular comprising a cast winding made of copper, a cast winding made of a copper alloy, a cast winding made of aluminum, a cast winding made of an aluminum alloy, a cast winding made of magnesium, a cast winding made of a conductive plastics material, a winding wound from a wire, or a subselection of these designs.
10. A rotating electric machine (21, 22, 23) comprising a laminated core and one or more windings (4, 4′, 4″), which each surround a tooth (2, 3) of the laminated core, characterized in that at least one, in particular a plurality of or all the teeth (2, 3) of the laminated core each comprise a retaining device for a slid-on winding, which, after sliding the winding onto the tooth, can be brought into a blocking position and prevents displacement and/or movement of the winding (4, 4′, 4″) on the tooth.
11. A rotating electric machine according to aspect 10, characterized in that the retaining device comprises a bar (24, 26), which can be slid or folded out of the contour of the relevant tooth (3) into a blocking position.
12. A rotating electric machine according to aspect 10 or 11, characterized in that a cast winding comprises cooling structures, preferably in the form of cooling ducts (27) or cooling fins (28).

1. A method for producing an electric machine comprising a laminated core and one or more windings, which each surround a tooth of the laminated core, the method comprising, proceeding from a defined construction of the electric machine comprising a defined laminated core of the electric machine to be produced, a winding design is allocated from a number of defined designs depending on one or more parameters comprising maximum torque, maximum power and minimal cooling power that correspond to a maximum value of a mean current density over time in the one or more windings and a price category, the defined designs comprising a cast winding made of copper, a cast winding made of a copper alloy, a cast winding made of aluminum, a cast winding made of an aluminum alloy, a cast winding made of magnesium, a cast winding made of a conductive plastics material, an insulating system, a list from which a design of the insulating system is selected comprising insulating systems of a 180° C. thermal class, 250° C. thermal class and a 300° C. thermal class, a cooling system, to which the one or more windings are connectable, selected from a group comprising an air cooling system, a direct water cooling system, an indirect water cooling system, or a subselection thereof.

2. The method according to claim 1, wherein the defined designs of windings available for selection in order to be allocated to the electric machine each have the same geometric dimensions.

3. The method according to claim 1, wherein a cast winding is equipped with cooling structures.

4. The method according to claim 1, wherein the permissible mean current density over time in the one or more cast windings made of copper or a copper alloy, for a time period, based thereon, of at least 1 minute,
has a maximum value of greater than 10 A/mm² when connected to an air cooling system,
has a maximum value of greater than 20 A/mm² when connected to an indirect water cooling system,
has a maximum value of greater than 60 A/mm² when connected to a direct water cooling system.

5. The method according to claim 1, wherein the permissible mean current density over time in the one or more cast windings made of aluminum or an aluminum alloy, for the 180° C. thermal class of the insulating system, for a time period, based thereon, of at least 1 minute,
has a maximum value of greater than 6 A/mm² when connected to an air cooling system,
has a maximum value of greater than 12 A/mm² when connected to an indirect water cooling system,
has a maximum value of greater than 35 A/mm² when connected to a direct water cooling system.

6. The method according to claim 1, wherein the permissible mean current density over time in the one or more cast windings made of aluminum or an aluminum alloy, for the 250° C. thermal class of the insulating system, for a time period, based thereon, of at least 1 minute,
has a maximum value of greater than 7 A/mm² when connected to an air cooling system,
has a maximum value of greater than 14 A/mm² when connected to an indirect water cooling system,
has a maximum value of greater than 45 A/mm² when connected to a direct water cooling system.

7. The method according to claim 1, wherein the permissible mean current density over time in the one or more cast windings made of aluminum or an aluminum alloy, for the 300° C. thermal class of the insulating system, for a time period, based thereon, of at least 1 minute,
has a maximum value of greater than 8 A/mm² when connected to an air cooling system,
has a maximum value of greater than 16 A/mm² when connected to an indirect water cooling system,
has a maximum value of greater than 56 A/mm² when connected to a direct water cooling system.

8. An apparatus for producing an electric machine comprising a laminated core and one or more windings, which each surround a tooth of the laminated core, the apparatus comprising a data-processing unit having a memory apparatus in which a plurality of different winding designs are stored which have the same outer dimensions, and the data-processing unit being configured to detect one or more parameters comprising maximum torque, maximum power and minimal cooling power that correspond to a maximum value of a mean current density over time in the one or more windings and a price category, and to allocate one of the winding designs stored in the memory apparatus to said windings proceeding from a defined construction of the machine comprising a defined laminated core, the winding designs comprising a cast winding made of copper, a cast winding made of a copper alloy, a cast winding made of aluminum, a cast winding made of an aluminum alloy, a cast winding made of magnesium, a cast winding made of a conductive plastics material, an insulating system, a list from which a design of the insulating system is selected comprising insulating systems of a 180° C. thermal class, a 250° C. thermal class and a 300° C. thermal class, a cooling system, to which the one or more windings can be connected, selected from a group comprising an air cooling system, a direct water cooling system, an indirect water cooling system, or a subselection of these designs.

9. An electric machine comprising a laminated core and one or more windings, which each surround a tooth of the laminated core, wherein at least one of the teeth of the laminated core each comprise a retaining device for a slid-on winding, which, after sliding the winding onto the tooth, is movable into a blocking position and prevents at least one of displacement and movement of the winding on the tooth.

10. The electric machine according to claim 9, wherein the retaining device comprises a bar, which is at least one of slidable and foldable out of the contour of the respective tooth into a blocking position.

11. The electric machine according to claim 9, wherein each winding comprises cooling structures.

12. A group comprising two or more electric machines comprising identically constructed laminated cores, the electric machines comprising windings which each surround teeth of the laminated cores, wherein at least two of the electric machines differ in terms of a design of the windings.

13. The group of electric machines according to claim 12, wherein the differing windings are selected from a group of designs, or a subselection of the group of designs, comprising: a cast winding made of copper, a cast winding made of a first copper alloy, a cast winding made of a second copper alloy, a cast winding made of aluminum, a cast winding made of a first aluminum alloy, a cast winding made of a second aluminum alloy, a cast winding made of magnesium, a cast winding made of a conductive plastics material.

14. The group of electric machines according to claim 12, wherein the differing windings are selected from a group of designs comprising: a cast winding made of copper, a cast winding made of a first copper alloy, and a cast winding made of a second copper alloy.

15. The group of electric machines according to claim 12, wherein the differing windings are selected from a group of designs comprising: a cast winding made of aluminum, a cast winding made of a first aluminum alloy, and a cast winding made of a second aluminum alloy.

16. The group of electric machines according to claim 12, wherein the differing windings are selected from a group of designs comprising: a cast winding made of a copper alloy, and a cast winding made of an aluminum alloy.

17. The group of electric machines according to claim 13, wherein the differing windings comprise an insulating system, a list from which a design of the insulating system is selected comprising insulating systems of the following thermal classes: a 180° C. thermal class, a 250° C. thermal class and a 300° C. thermal class.

18. The group of electric machines according to claim 12, wherein the differing windings are connectable to a cooling system, the cooling system being selected from a group comprising: an air cooling system, a direct water cooling system, and an indirect water cooling system.

19. The electric machine according to claim 11, wherein the cooling structures comprise at least one of cooling ducts and cooling fins.

20. The electric machine according to claim 12, wherein the differing windings are selected from different cast windings.
